(19) United States
(12) Patent Application Publication
(10) Pub. No.: US 2026/0045843 A1
(43) Pub. Date: Feb. 12, 2026

(54) METHOD FOR PRODUCING STATOR AND STATOR

(71) Applicants: AISIN CORPORATION, Kariya (JP); TOYOTA JIDOSHA KABUSHIKI KAISHA, Toyota-shi (JP)

(72) Inventors: Yoshiki YAMAUCHI, Kariya-shi (JP); Tetsuya Matsubara, Kariya-shi (JP); Osamu Nakagawa, Kariya-shi (JP); Keisuke Ito, Toyota-shi (JP)

(73) Assignees: AISIN CORPORATION, KARIYA (JP); TOYOTA JIDOSHA KABUSHIKI KAISHA, Toyota-shi (JP)

(21) Appl. No.: 19/267,134

(22) Filed: Jul. 11, 2025

(30) Foreign Application Priority Data
Aug. 7, 2024 (JP) 2024-131062

(51) Int. Cl. H02K 3/12; H02K 1/16; H02K 15/085

(52) U.S. Cl. CPC H02K 3/12; H02K 1/16; H02K 15/085

(57) ABSTRACT

A method for producing a stator includes: a segment coil insertion step of inserting a segment coil including a coil end part serving as a coil end portion into each of a plurality of slots of a stator core such that the coil end part protrudes from an end surface of the stator core in an axial direction to an outer side in the axial direction; and a bending step of bending each of a plurality of the coil end parts in a circumferential direction of the stator core up to a tip end portion of each of the plurality of coil end parts by relatively moving a bending jig with respect to the stator core in a direction along the circumferential direction with each of the plurality of coil end parts inserted into a recess of the bending jig, the recess extending along the coil end part.

### CROSS REFERENCE TO RELATED APPLICATIONS

This application is based on and claims priority under 35 U.S.C. § 119 to Japanese Patent Application 2024-131062, filed on Aug. 7, 2024, the entire content of which is incorporated herein by reference.

### TECHNICAL FIELD

This disclosure relates to a method for producing a stator and a stator.

### BACKGROUND DISCUSSION

In related art, there has been known a method for producing a stator in which each of a plurality of coil end parts is bent in a circumferential direction (for example, see JP 2020-61897A (Reference 1)).

Reference 1 discloses a method for producing a rotary electric machine stator (method for producing a stator) in which each of protruding portions (coil end parts) of a plurality of segment coils is bent in a circumferential direction by moving an alignment jig (bending jig) in the circumferential direction with respect to a stator core while bringing the alignment jig close to the stator core, with a tip end portion of each of the protruding portions of the plurality of segment coils being pressed with a claw portion of the alignment jig.

However, in the method for producing a rotary electric machine stator (method for producing a stator) described in Reference 1, when bending each of the protruding portions (coil end parts) of the plurality of segment coils in the circumferential direction, the tip end portion of the protruding portion of the segment coil is pressed by the claw portion of the alignment jig (bending jig), so that when bending each of the protruding portions of the plurality of segment coils in the circumferential direction, a load application point of the alignment jig on the protruding portion of the segment coil is normally an end portion of the protruding portion of the segment coil on an alignment jig side. That is, when bending each of the protruding portions of the plurality of segment coils in the circumferential direction, the load application point of the alignment jig on the protruding portion of the segment coil is normally located at a position relatively far from the end portion of the protruding portion of the segment coil on a stator core side. In this case, since a radius of curvature of a curved portion of each of the protruding portions of the plurality of segment coils on the stator core side after being bent in the circumferential direction is likely to be relatively large, a degree of bending of the curved portion is likely to be gentle. Accordingly, a length of a coil end portion in an axial direction is likely to be relatively large. Therefore, there is a demand for a technique capable of making a length (height) of a coil end portion in an axial direction relatively small.

A need thus exists for a method for producing a stator and a stator which are not susceptible to the drawback mentioned above.

### SUMMARY

A method for producing a stator according to a first aspect of this disclosure includes: a segment coil insertion step of inserting a segment coil including a coil end part serving as a coil end portion into each of a plurality of slots of a stator core such that the coil end part protrudes from an end surface of the stator core in an axial direction along the axial direction to an outer side in the axial direction; and a bending step of, after the segment coil insertion step, bending each of a plurality of the coil end parts in a circumferential direction of the stator core up to a tip end portion of each of the plurality of coil end parts by relatively moving a bending jig with respect to the stator core in a direction along the circumferential direction with each of the plurality of coil end parts inserted into a recess of the bending jig, the recess extending along the coil end part.

A stator according to a second aspect of this disclosure includes: a stator core including a slot; and a coil formed by joining a plurality of segment coils, each of which includes a slot housing portion housed in the slot and a coil end portion protruding from an end surface of the stator core in an axial direction along the axial direction to an outer side in the axial direction, wherein the coil end portion is bent in a circumferential direction of the stator core up to a tip end portion, and includes a root portion connected to the slot housing portion, an intermediate portion connected to the root portion, and the tip end portion connected to the intermediate portion and inclined to a side close to being parallel to the axial direction with respect to the intermediate portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view illustrating a stator according to an embodiment disclosed here;

FIG. 2 is a schematic view illustrating a coil of the stator according to the embodiment disclosed here;

FIG. 3 is a diagram illustrating a stator producing flow according to the embodiment disclosed here;

FIG. 4 is a diagram illustrating a stator core forming step in the stator producing flow according to the embodiment disclosed here;

FIG. 5 is a diagram illustrating a segment coil forming step in the stator producing flow according to the embodiment disclosed here;

FIG. 6 is a diagram illustrating a segment coil insertion step in the stator producing flow according to the embodiment disclosed here;

FIG. 7 is a diagram (1) illustrating a bending step in the stator producing flow according to the embodiment disclosed here;

FIG. 8 is a diagram illustrating a bending jig used in the bending step in the stator producing flow according to the embodiment disclosed here;

FIG. 9 is a diagram (2) illustrating the bending step in the stator producing flow according to the embodiment disclosed here;

FIG. 10 is a diagram (3) illustrating the bending step in the stator producing flow according to the embodiment disclosed here;

FIG. 11 is a diagram (4) illustrating the bending step in the stator producing flow according to the embodiment disclosed here;

FIG. 12 is a diagram (5) illustrating the bending step in the stator producing flow according to the embodiment disclosed here;

FIG. 13 is a diagram (6) illustrating the bending step in the stator producing flow according to the embodiment disclosed here; and

FIG. 14 is a diagram illustrating a segment coil joining step in the stator producing flow according to the embodiment disclosed here.

### DETAILED DESCRIPTION

Hereinafter, an embodiment disclosed here will be described with reference to the drawings. In the present specification, the term “recess” is a broad concept including a slit-shaped recess, a groove-shaped recess, a hole-shaped recess, and the like. In the present specification, the term “direction along the . . . direction” is a broad concept including both the . . . direction itself and a direction relatively close to the . . . direction.

### Configuration of Stator

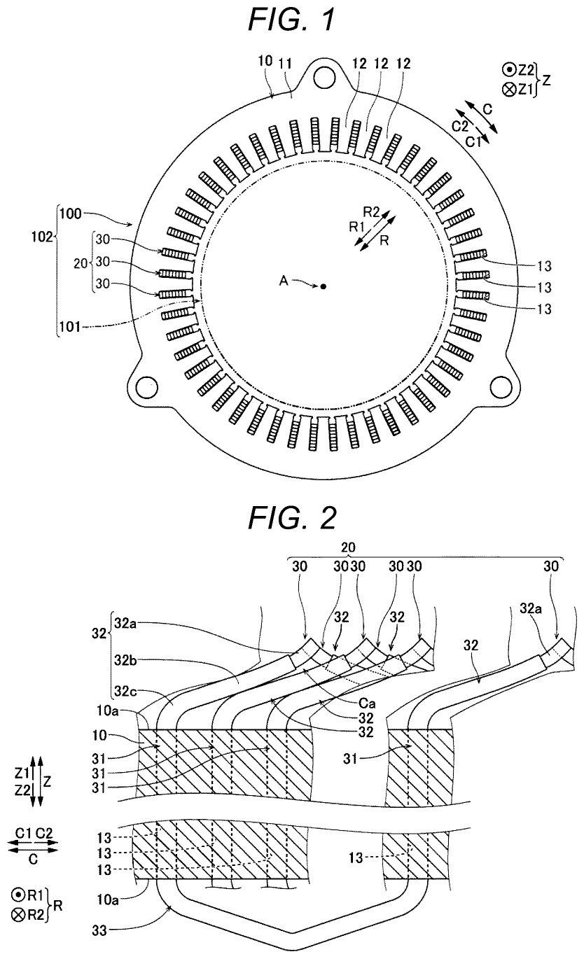

A configuration of a stator 100 according to the embodiment disclosed here will be described with reference to FIGS. 1 and 2.

In the following description, an axial direction, a radial direction, and a circumferential direction of a stator core 10 (see FIG. 1) included in the stator 100 are referred to as a Z direction, an R direction, and a C direction, respectively. One side and the other side of the axial direction (Z direction) are defined as a Z1 direction and a Z2 direction, respectively. A direction from a radially outer side of the stator core 10 in the radial direction (R direction) toward a central axis A is defined as an R1 direction, and a direction from the central axis A of the stator core 10 toward the radially outer side is defined as an R2 direction. One side and the other side of the circumferential direction (C direction) are defined as a C1 direction and a C2 direction, respectively.

### Overall Configuration of Stator

As illustrated in FIG. 1, the stator 100 constitutes a part of an inner rotor type rotary electric machine 102 together with a rotor 101 disposed on the R1 direction side of the stator 100 so as to face the stator 100. The rotary electric machine 102 is, for example, a motor, a generator, or a motor/generator.

The stator 100 includes the stator core 10 and a coil 20.

### Configuration of Stator Core

The stator core 10 has a cylindrical shape with the central axis A along the Z direction as a central axis. The stator core 10 is formed by stacking a plurality of electromagnetic steel plates (for example, silicon steel plates) in the Z direction.

The stator core 10 includes an annular back yoke 11 and a plurality of teeth 12 protruding from the back yoke 11 in the R1 direction and arranged in the C direction. A slot 13 is formed between each pair of teeth 12 adjacent to each other in the C direction. That is, the stator core 10 includes a plurality of slots 13 arranged in the C direction. Each of the plurality of teeth 12 and the plurality of slots 13 extends in the Z direction from an end surface 10a (see FIG. 2) of the stator core 10 in the Z1 direction to the end surface 10a in the Z2 direction.

### Configuration of Coil

The coil 20 includes a conductive wire containing any one of copper, a copper alloy, aluminum, and an aluminum alloy as a main component, and an insulating film covering the conductive wire. The coil 20 generates a magnetic flux when supplied with three-phase alternating current power. In FIG. 1, parts of the coil 20 other than slot housing portions 31 (see FIG. 2) are not illustrated.

As illustrated in FIG. 2, the coil 20 is formed by joining a plurality of segment coils 30. The plurality of segment coils 30 each include a pair of slot housing portions 31 housed in the slots 13, a pair of one-side coil end portions 32 protruding in the Z1 direction from the end surface 10a of the stator core 10 in the Z2 direction, and an other-side coil end portion 33 protruding in the Z2 direction from the end surface 10a of the stator core 10 in the Z2 direction. The one-side coil end portion 32 is an example of a “coil end portion” in the claims.

The pair of slot housing portions 31 is housed (inserted) in different slots 13. Each of tip end portions 32a of the pair of one-side coil end portions 32 is joined (connected) by welding to the tip end portion 32a of the one-side coil end portion 32 of another segment coil 30 on the Z1 direction side of the stator core 10. The other-side coil end portion 33 connects the pair of slot housing portions 31 on the Z2 direction side of the stator core 10.

As illustrated in FIG. 1, the plurality of segment coils 30 (including the slot housing portions 31 (see FIG. 2)) arranged in the R direction are housed in each of the plurality of slots 13. FIG. 1 illustrates an example in which eight segment coils 30 arranged in the R direction are housed in each of the plurality of slots 13.

As illustrated in FIG. 2, the tip end portion 32a of the one-side coil end portion 32 of the (n+2k)th turn segment coil 30 and the tip end portion 32a of the one-side coil end portion 32 of the (n+2k+1)th turn segment coil 30 are joined (connected) by welding, where n≥1 and k≥0. “The . . . th turn segment coil 30” means the segment coil 30 in the . . . row from an inner diameter side of the stator core 10.

The one-side coil end portion 32 of the (n+2k)th turn segment coil 30 is bent in the C2 direction (circumferential direction) up to the tip end portion 32a. The one-side coil end portion 32 of the (n+2k)th turn segment coil 30 includes a root portion 32c connected to the slot housing portion 31, an intermediate portion 32b connected to the root portion 32c and inclined to the C2 direction with respect to the end surface 10a of the stator core 10 in the Z direction as being away in the Z1 direction from the end surface 10a of the stator core 10 in the Z1 direction, and the tip end portion 32a connected to the intermediate portion 32b and inclined to a side close to being parallel to the Z direction (axial direction) with respect to the intermediate portion 32b. The one-side coil end portion 32 of the (n+2k)th turn segment coil 30 is configured such that a gap Ca between the one-side coil end portion 32 and another one-side coil end portion 32 adjacent thereto in the C2 direction (circumferential direction) gradually widens from the intermediate portion 32b toward the tip end portion 32a. The root portion 32c is curved to connect an end portion of the slot housing portion 31 in the Z1 direction and an end portion of the intermediate portion 32b in the Z2 direction (on an inner side in the axial direction). The root portion 32c is curved to be gradually inclined to a side away from being parallel to the Z direction (axial direction) as approaching the intermediate portion 32b. The intermediate portion 32b extends linearly or is curved to be gradually inclined to a side close to being parallel to the Z direction (axial direction) as approaching the tip end portion 32a. The tip end portion 32a is curved to be inclined to a side close to being parallel to the Z direction (axial direction) as approaching a tip end.

The one-side coil end portion 32 of the (n+2k+1)th turn segment coil 30 is bent in the C1 direction (circumferential direction) up to the tip end portion 32a. The one-side coil end portion 32 of the (n+2k+1)th turn segment coil 30 includes the root portion 32c connected to the slot housing portion 31, the intermediate portion 32b connected to the root portion 32c and inclined to the C1 direction with respect to the end surface 10a of the stator core 10 in the Z direction as being away in the Z1 direction from the end surface 10a of the stator core 10 in the Z1 direction, and the tip end portion 32a connected to the intermediate portion 32b and inclined to the side close to being parallel to the Z direction (axial direction) with respect to the intermediate portion 32b. The one-side coil end portion 32 of the (n+2k+1)th turn segment coil 30 is configured such that the gap Ca between the one-side coil end portion 32 and another one-side coil end portion 32 adjacent thereto in the C1 direction (circumferential direction) gradually widens from the intermediate portion 32b toward the tip end portion 32a. The root portion 32c is curved to connect the end portion of the slot housing portion 31 in the Z1 direction and the end portion of the intermediate portion 32b in the Z2 direction (on the inner side in the axial direction). The root portion 32c is curved to be gradually inclined to the side away from being parallel to the Z direction (axial direction) as approaching the intermediate portion 32b. The intermediate portion 32b extends linearly or is curved to be gradually inclined to the side close to being parallel to the Z direction (axial direction) as approaching the tip end portion 32a. The tip end portion 32a is curved to be inclined to the side close to being parallel to the Z direction (axial direction) as approaching the tip end.

### Method for Producing Stator

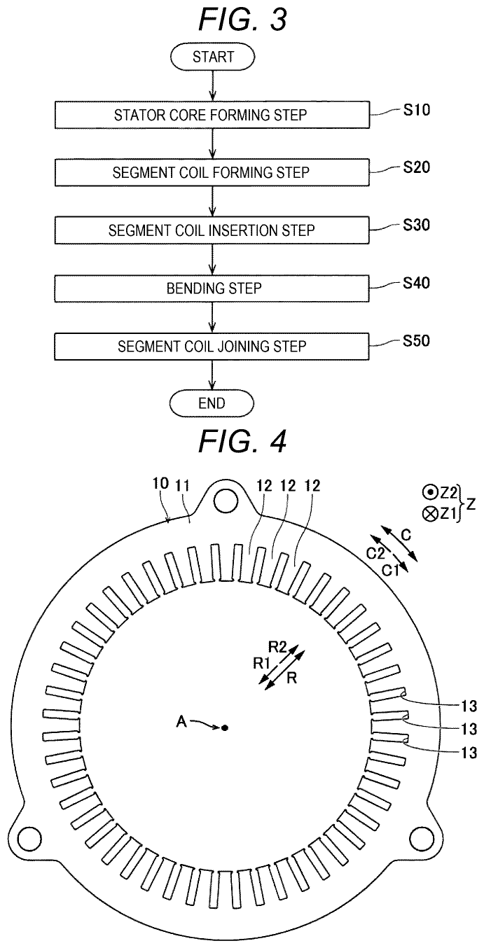

A method for producing the stator 100 according to the embodiment disclosed here will be described with reference to FIGS. 3 to 14.

### Stator Core Forming Step

As illustrated in FIG. 3, in step S10, a stator core forming step is performed. As illustrated in FIG. 4, the stator core forming step (S10) is a step of forming the stator core 10 including the plurality of slots 13 arranged in the C direction.

### Segment Coil Forming Step

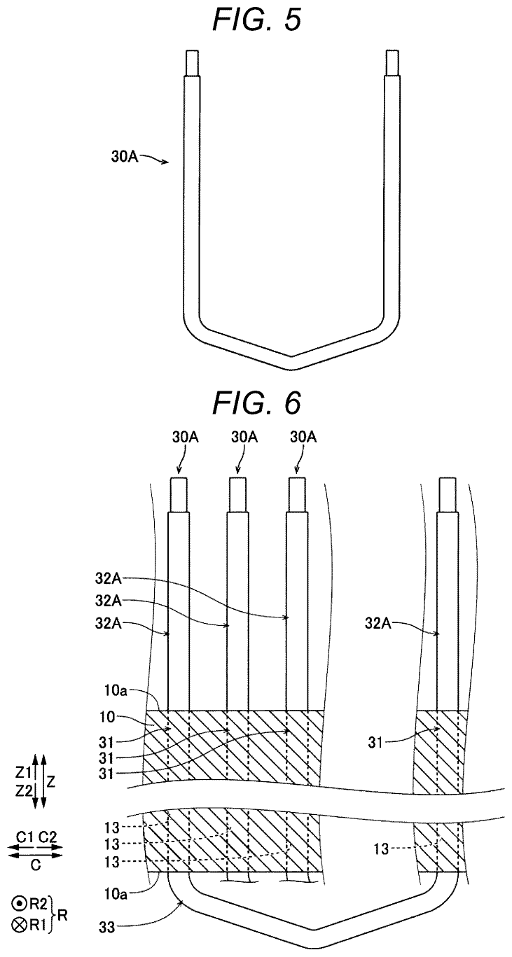

As illustrated in FIG. 3, in step S20, a segment coil forming step is performed. As illustrated in FIG. 5, the segment coil forming step (S20) is a step of forming a substantially U-shaped segment coil 30A. The segment coil 30A is an example of a “segment coil (including a coil end part)” in the claims.

### Segment Coil Insertion Step

As illustrated in FIG. 3, in step S30, a segment coil insertion step is performed. As illustrated in FIG. 6, the segment coil insertion step (S30) is a step of inserting the segment coil 30A including a coil end part 32A into each of the plurality of slots 13 of the stator core 10 such that the coil end part 32A serving as the one-side coil end portion 32 protrudes in the Z1 direction (to an outer side in the axial direction) from the end surface 10a of the stator core 10 in the Z1 direction along the Z direction. The pair of slot housing portions 31 and the other-side coil end portion 33 of the segment coil 30 (see FIG. 2) are formed with the segment coil 30A including the coil end part 32A inserted into each of the plurality of slots 13 of the stator core 10.

### Bending Step

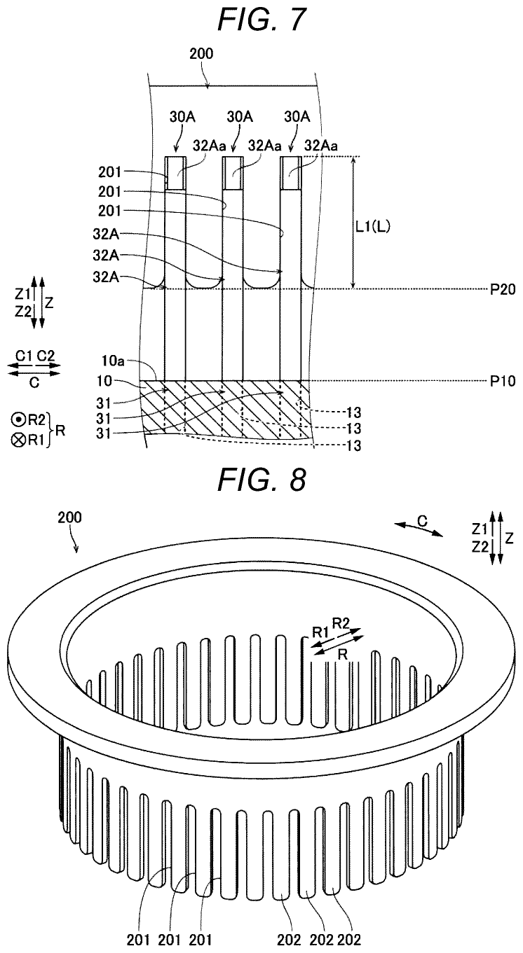

As illustrated in FIG. 3, in step S40, a bending step is performed. As illustrated in FIGS. 7 and 9 to 13, the bending step (S40) is a step of bending each of the plurality of coil end parts 32A in the C direction up to a tip end portion 32Aa of each of the plurality of coil end parts 32A by moving a bending jig 200 with respect to the stator core 10 in the direction along the C direction (circumferential direction) with each of the plurality of coil end parts 32A inserted into a recess 201 of the bending jig 200, the recess 201 extending along the coil end part 32A. Specifically, the bending step (S40) is a step of bending each of the plurality of coil end parts 32A in the C direction up to the tip end portion 32Aa of each of the plurality of coil end parts 32A by moving the bending jig 200 with respect to the stator core 10 in the direction along the C direction before the tip end portion 32Aa of each of the plurality of coil end parts 32A is detached from the recess 201 of the bending jig 200, and moving the bending jig 200 with respect to the stator core 10 while bringing the tip end portion 32Aa of each of the plurality of coil end parts 32A into contact with a protrusion 202 located at an end portion of the bending jig 200 on the stator core 10 side after the tip end portion 32Aa of each of the plurality of coil end parts 32A is detached from the recess 201 of the bending jig 200.

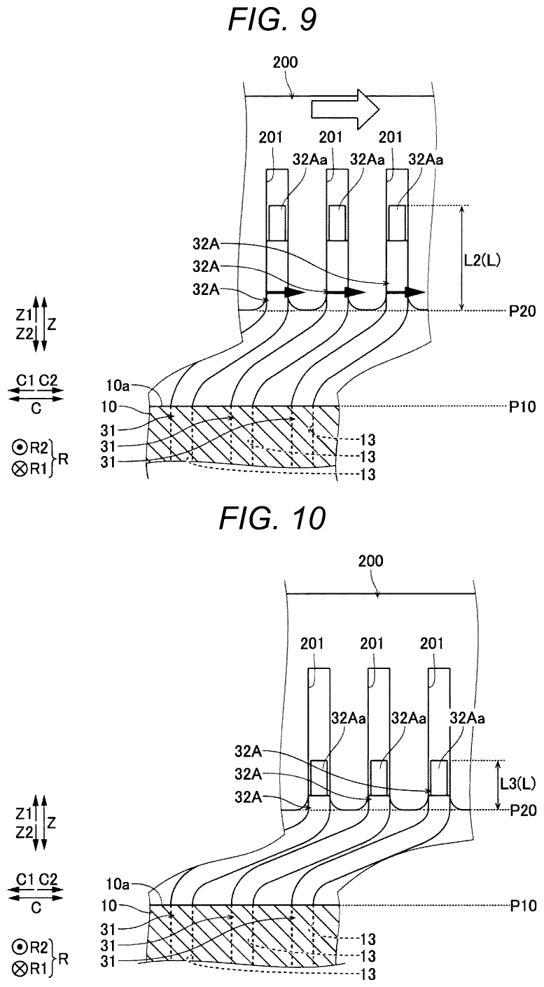

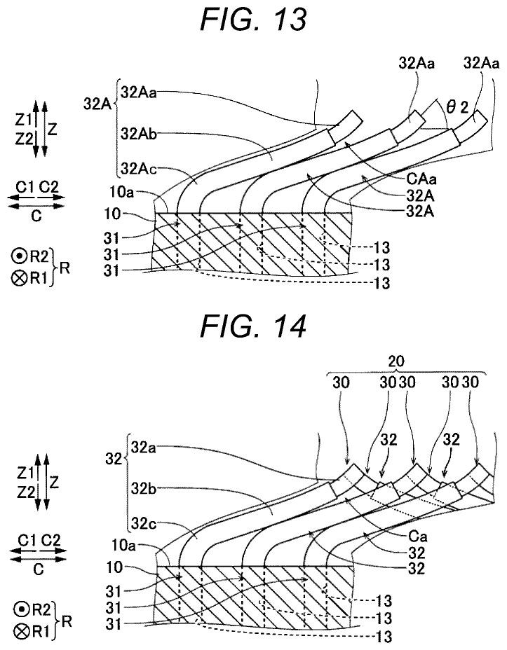

First, as illustrated in FIG. 7, each of the plurality of coil end parts 32A is inserted into the recess 201 of the bending jig 200 extending along the coil end part 32A. As illustrated in FIG. 8, the bending jig 200 is formed in an annular shape. The bending jig 200 includes a plurality of recesses 201 arranged in the C direction. Each of the plurality of recesses 201 extends in the Z direction. Each of the plurality of recesses 201 is formed in a slit shape opening toward the stator core 10 side. Each of the plurality of recesses 201 is formed at a position corresponding to each of the plurality of slots 13 of the stator core 10. The protrusion 202 is formed between each pair of recesses 201 adjacent to each other in the C direction. That is, the bending jig 200 includes a plurality of protrusions 202 arranged in the C direction. As illustrated in FIGS. 9 to 11, before the tip end portion 32Aa of each of the plurality of coil end parts 32A is detached from the recess 201 of the bending jig 200, the bending jig 200 is moved with respect to the stator core 10 in the direction along the C direction (circumferential direction) with each of the plurality of coil end parts 32A inserted into the recess 201 of the bending jig 200. As illustrated in FIG. 12, after the tip end portion 32Aa of each of the plurality of coil end parts 32A is detached from the recess 201 of the bending jig 200, the bending jig 200 is moved with respect to the stator core 10 while bringing the tip end portion 32Aa of each of the plurality of coil end parts 32A into contact with the protrusion 202 of the bending jig 200. As illustrated in FIG. 13, when the bending jig 200 moves away from the stator core 10, the tip end portion 32Aa of each of the plurality of coil end parts 32A that is pressed by the protrusion 202 of the bending jig 200 returns (springs back) due to elasticity, and a bending angle (warpage angle) of the tip end portion 32Aa of each of the coil end parts 32A becomes θ2. In this way, each of the plurality of coil end parts 32A is bent in the C direction up to the tip end portion 32Aa of each of the plurality of coil end parts 32A.

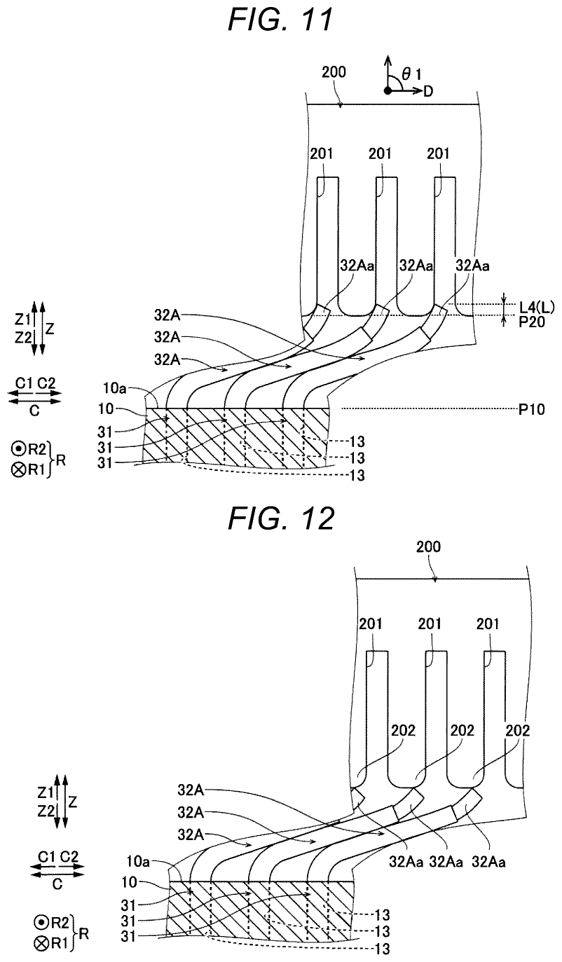

As illustrated in FIGS. 7 and 9 to 12, the bending step (S40) is a step of bending each of the plurality of coil end parts 32A in the C direction up to the tip end portion 32Aa of each of the plurality of coil end parts 32A while moving the bending jig 200 with respect to the stator core 10 in the direction along the C direction (circumferential direction) such that a length L of a portion of each of the plurality of coil end parts 32A that is inserted into the recess 201 of the bending jig 200 is gradually reduced. Specifically, as each of the plurality of coil end parts 32A is bent in the C1 direction or the C2 direction from the state of extending along the Z direction, the tip end portion 32Aa of each of the plurality of coil end parts 32A gradually moves closer to the stator core 10. When bending each of the plurality of coil end parts 32A in the C direction, the bending jig 200 is moved with respect to the stator core 10 in the direction along the C direction (circumferential direction). Therefore, the length L of the portion of each of the plurality of coil end parts 32A that is inserted into the recess 201 of the bending jig 200 is gradually reduced. That is, as illustrated in FIG. 7, at the time when bending of each of the plurality of coil end parts 32A in the C direction begins, the length L of the portion of each of the plurality of coil end parts 32A that is inserted into the recess 201 of the bending jig 200 is L1. As illustrated in FIG. 9, when the bending of each of the plurality of coil end parts 32A in the C direction progresses, the length L of the portion of each of the plurality of coil end parts 32A that is inserted into the recess 201 of the bending jig 200 becomes L2, which is smaller than L1. As illustrated in FIG. 10, when the bending of each of the plurality of coil end parts 32A in the C direction further proceeds, the length L of the portion of each of the plurality of coil end parts 32A that is inserted into the recess 201 of the bending jig 200 becomes L3, which is smaller than L2. As illustrated in FIG. 11, when the bending of each of the plurality of coil end parts 32A in the C direction further proceeds, the length L of the portion of each of the plurality of coil end parts 32A that is inserted into the recess 201 of the bending jig 200 becomes L4, which is smaller than L3. As illustrated in FIG. 12, when the tip end portion 32Aa of each of the plurality of coil end parts 32A is detached from the recess 201 of the bending jig 200, the length L of the portion of each of the plurality of coil end parts 32A that is inserted into the recess 201 of the bending jig 200 becomes zero.

As illustrated in FIGS. 7 and 9 to 12, the bending step (S40) is a step of bending each of the plurality of coil end parts 32A in the C direction up to the tip end portion 32Aa of each of the plurality of coil end parts 32A while moving a load application point of the bending jig 200 on the coil end part 32A from the stator core 10 side to the bending jig 200 side in the coil end part 32A by moving the bending jig 200 with respect to the stator core 10 in the direction along the C direction (circumferential direction) such that the length L of the portion of each of the plurality of coil end parts 32A that is inserted into the recess 201 of the bending jig 200 is gradually reduced. Specifically, as illustrated in FIG. 9, a load applied to the coil end part 32A by the bending jig 200 acts on the portion of each of the plurality of coil end parts 32A that is inserted into the recess 201 of the bending jig 200 (mainly an end portion on the stator core 10 side). Therefore, as the length L of the portion of each of the plurality of coil end parts 32A that is inserted into the recess 201 of the bending jig 200 is gradually reduced, the load application point of the bending jig 200 on the coil end part 32A gradually moves from the stator core 10 side to the bending jig 200 side of the coil end part 32A.

As illustrated in FIG. 7 and 9 to 12, the bending step (S40) is a step of bending each of the plurality of coil end parts 32A in the C direction up to the tip end portion 32Aa of each of the plurality of coil end parts 32A while moving the bending jig 200 with respect to the stator core 10 in a direction parallel to the end surface 10a of the stator core 10 (a direction along the direction parallel to the end surface 10a of the stator core 10) and in a direction along the C direction (circumferential direction). Therefore, before the tip end portion 32Aa of each of the plurality of coil end parts 32A is detached from the recess 201 of the bending jig 200, a position of the bending jig 200 in the Z direction (for example, a position P20 of the end portion of the bending jig 200 on the stator core 10 side in the Z direction) does not change with respect to a position P10 of the end surface 10a of the stator core 10 in the Z direction when viewed from the R direction.

As illustrated in FIGS. 7 and 9 to 13, the bending step (S40) is a step of bending each of the plurality of coil end parts 32A in the C direction up to the tip end portion 32Aa of each of the plurality of coil end parts 32A while adjusting the bending angle θ2 (see FIG. 13) of the tip end portion 32Aa of each of the plurality of coil end parts 32A by moving the bending jig 200 with respect to the stator core 10 in the direction along the C direction before the tip end portion 32Aa of each of the plurality of coil end parts 32A is detached from the recess 201 of the bending jig 200 and adjusting a direction D (see FIG. 11) of movement of the bending jig 200 with respect to the stator core 10 when the tip end portion 32Aa of each of the plurality of coil end parts 32A is detached from the recess 201 of the bending jig 200. As illustrated in FIG. 11, when the bending angle θ2 of the tip end portion 32Aa of each of the plurality of coil end parts 32A is adjusted, the direction D of the movement of the bending jig 200 with respect to the stator core 10 is a direction in which an angle θ1 with respect to the Z direction is equal to or greater than 0 degrees and equal to or less than 90 degrees. That is, the direction D of the movement of the bending jig 200 with respect to the stator core 10 is a direction parallel to the Z direction (θ1=0 degrees) or a direction inclined to a C direction side with respect to the Z direction when viewed from the R direction (0 degrees<θ1≤90 degrees). By adjusting the angle θ1 in the range of 0 degrees to 90 degrees, the direction D of the movement of the bending jig 200 with respect to the stator core 10 is adjusted. FIGS. 11 and 12 illustrate an example in which the angle θ1 is 90 degrees.

The direction D of the movement of the bending jig 200 with respect to the stator core 10 is determined and adjusted in advance through experiments and the like from the viewpoint of ensuring an insulation distance of the tip end portion 32a of the one-side coil end portion 32 and the viewpoint of ensuring a joining area of the tip end portion 32a of the one-side coil end portion 32. For example, when the insulation distance of the tip end portion 32a of the one-side coil end portion 32 is secured to be relatively large, the direction D of the movement of the bending jig 200 with respect to the stator core 10 is adjusted such that the angle θ1 is relatively small in order to relatively increase the bending angle θ2. For example, when the insulation distance of the tip end portion 32a of the one-side coil end portion 32 is secured to be relatively small, the direction D of the movement of the bending jig 200 with respect to the stator core 10 is adjusted such that the angle θ1 is relatively large in order to relatively reduce the bending angle θ2. For example, when the joining area of the tip end portion 32a of the one-side coil end portion 32 is secured, the direction D of the movement of the bending jig 200 with respect to the stator core 10 is adjusted so as to obtain the bending angle θ2 at which optimal mating surface welding can be performed. For example, FIG. 13 illustrates an example in which the direction D of the movement of the bending jig 200 with respect to the stator core 10 is adjusted such that the bending angle θ2 is about 45 degrees. In this case, as illustrated in FIG. 14, the tip end portions 32a joined to each other can be largely overlapped with each other as compared with the case where the bending angle θ2 is not 45 degrees, and thus a necessary joining area can be easily secured. The bending angle θ2 is an angle at which the tip end portion 32Aa of the coil end part 32A is inclined with respect to the direction parallel to the end surface 10a of the stator core 10 when viewed from the R direction.

As illustrated in FIG. 13, the bending step (S40) is a step of bending each of the plurality of coil end parts 32A in the C direction up to the tip end portion 32Aa of each of the plurality of coil end parts 32A such that the tip end portion 32Aa of each of the plurality of coil end parts 32A is inclined to a side close to being parallel to the Z direction (axial direction) with respect to the intermediate portion 32Ab connected to the root portion 32Ac. Specifically, the bending step (S40) is a step of bending each of the plurality of coil end parts 32A in the C direction up to the tip end portion 32Aa of each of the plurality of coil end parts 32A such that a gap CAa between the coil end part 32A and another coil end part 32A adjacent thereto in the C direction gradually widens from an intermediate portion 32Ab toward the tip end portion 32Aa. More specifically, the bending step (S40) is a step of bending each of the plurality of coil end parts 32A in the circumferential direction up to the tip end portion 32Aa of each of the plurality of coil end parts 32A such that a root portion 32Ac is curved to be gradually inclined to a side away from being parallel to the Z direction (axial direction) as approaching the intermediate portion 32Ab, the intermediate portion 32Ab extends linearly, or is curved to be gradually inclined to a side close to being parallel to the Z direction (axial direction) as approaching the tip end portion 32Aa, and the tip end portion 32Aa is curved to be gradually inclined to a side close to being parallel to the Z direction (axial direction) as approaching a tip end.

As illustrated in FIG. 7 and 9 to 12, as the bending of each of the plurality of coil end parts 32A in the C direction progresses, the load application point of the bending jig 200 on the coil end part 32A moves from the stator core 10 side to the bending jig 200 side in the coil end part 32A, and thus the coil end part 32A on the stator core 10 side is more likely to be curved to be gradually inclined to the side close to being parallel to the Z direction (axial direction) as approaching the tip end portion 32Aa as compared with the coil end part 32A on bending jig 200 side. As illustrated in FIGS. 10 and 11, when the tip end portion 32Aa of each of the plurality of coil end parts 32A is detached from the recess 201 of the bending jig 200, one side surface of the tip end portion 32Aa of the coil end part 32A continues to come into contact with one side surface of the recess 201, whereas the other side surface of the tip end portion 32Aa of the coil end part 32A gradually does not come into contact with the other side surface of the recess 201, so that the tip end portion 32Aa of the coil end part 32A is more likely to be curved to be gradually inclined to the side close to being parallel to the Z direction (axial direction) as approaching the tip end. Therefore, the tip end portion 32Aa is curved to be gradually inclined to the side close to being parallel to the Z direction (axial direction) as approaching the tip end. Therefore, the gap CAa between the coil end part 32A and another coil end part 32A adjacent thereto in the C direction gradually widens from the intermediate portion 32Ab toward the tip end portion 32Aa.

### Segment Coil Joining Step

As illustrated in FIG. 3, in step S50, a segment coil joining step is performed. As illustrated in FIG. 14, the segment coil joining step (S50) is a step of forming the coil 20 by joining the plurality of segment coils 30. Specifically, the tip end portion 32a of the one-side coil end portion 32 of the (n+2k)th turn segment coil 30 and the tip end portion 32a of the one-side coil end portion 32 of the (n+2k+1)th turn segment coil 30 are joined (connected) to each other by welding.

### Effects of Embodiment

In the present embodiment, the following effects can be obtained.

In the present embodiment, as described above, the bending step (40) is a step of bending each of the plurality of coil end parts 32A in the C direction up to the tip end portion 32Aa of each of the plurality of coil end parts 32A by moving the bending jig 200 with respect to the stator core 10 in the direction along the C direction (circumferential direction) of the stator core 10 with each of the plurality of coil end parts 32A inserted into the recess 201 of the bending jig 200, the recess 201 extending along the coil end part 32A. Accordingly, when each of the plurality of coil end parts 32A is bent in the C direction, the length of the portion of each of the plurality of coil end parts 32A that is inserted into the recess 201 of the bending jig 200 is gradually reduced, and thus the load application point of the bending jig 200 on the coil end part 32A can be moved from the stator core 10 side to the bending jig 200 side in the coil end part 32A. That is, when each of the plurality of coil end parts 32A is bent in the C direction, the load application point of the bending jig 200 on the coil end part 32A changes from the position relatively close to the end portion of the coil end part 32A on the stator core 10 side to the position relatively far from the end portion. Accordingly, when each of the plurality of coil end parts 32A is bent in the C direction, the radius of curvature of the root portion 32Ac of each of the plurality of coil end parts 32A (curved portion on the stator core 10 side) after being bent in the C direction can be reduced as compared with the case where the load application point of the bending jig 200 on the coil end part 32A is normally located at the position relatively far from the end portion of the coil end part 32A on the stator core 10 side, and thus a degree of bending of the root portion 32Ac (curved portion) can be increased. As a result, the length (height) of the one-side coil end portion 32 (coil end portion) in the Z direction (axial direction) can be made relatively small. Each of the plurality of coil end parts 32A is bent in the C direction up to the tip end portion 32Aa of each of the plurality of coil end parts 32A, and thus the length (height) of the coil end part 32A in the Z direction can be reduced as compared with the case where the tip end portion 32Aa of each of the plurality of coil end parts 32A is not bent. Accordingly, the length (height) of the one-side coil end portion 32 in the Z direction can be relatively small.

In the present embodiment, as described above, the bending step (40) is a step of bending each of the plurality of coil end parts 32A in the C direction up to the tip end portion 32Aa of each of the plurality of coil end parts 32A by moving the bending jig 200 with respect to the stator core 10 in the direction along the C direction (circumferential direction) before the tip end portion 32Aa of each of the plurality of coil end parts 32A is detached from the recess 201 of the bending jig 200, and moving the bending jig 200 with respect to the stator core 10 while bringing the tip end portion 32Aa of each of the plurality of coil end parts 32A into contact with the protrusion 202 located at the end portion of the bending jig 200 on the stator core 10 side after the tip end portion 32Aa of each of the plurality of coil end parts 32A is detached from the recess 201 of the bending jig 200. Accordingly, the length of the portion of each of the plurality of coil end parts 32A that is inserted into the recess 201 of the bending jig 200 is gradually reduced by relatively moving the bending jig 200 with respect to the stator core 10 in the direction along the C direction before the tip end portion 32Aa of each of the plurality of coil end parts 32A is detached from the recess 201 of the bending jig 200, and thus the load application point of the bending jig 200 on the coil end part 32A can be reliably moved from the stator core 10 side to the bending jig 200 side in the coil end part 32A. Accordingly, when each of the plurality of coil end parts 32A is bent in the C direction, the radius of curvature of the root portion 32Ac of each of the plurality of coil end parts 32A (curved portion on the stator core 10 side) after being bent in the C direction can be reliably reduced as compared with the case where the load application point of the bending jig 200 on the coil end part 32A is normally located at the position relatively far from the end portion of the coil end part 32A on the stator core 10 side. The tip end portion 32Aa of each of the plurality of coil end parts 32A can be pressed by the protrusion 202 of the bending jig 200 by moving the bending jig 200 with respect to the stator core 10 while bringing the tip end portion 32Aa of each of the plurality of coil end parts 32A into contact with the protrusion 202 located at the end portion of the bending jig 200 on the stator core 10 side after the tip end portion 32Aa of each of the plurality of coil end parts 32A is detached from the recess 201 of the bending jig 200, and thus the length (height) of the coil end part 32A in the Z direction (axial direction) can be reliably reduced.

In the present embodiment, as described above, the bending step (40) is a step of bending each of the plurality of coil end parts 32A in the C direction (circumferential direction) up to the tip end portion 32Aa of each of the plurality of coil end parts 32A while adjusting the bending angle θ2 of the tip end portion 32Aa of each of the plurality of coil end parts 32A by moving the bending jig 200 with respect to the stator core 10 in the direction along the C direction before the tip end portion 32Aa of each of the plurality of coil end parts 32A is detached from the recess 201 of the bending jig 200 and adjusting the direction D of the movement of the bending jig 200 with respect to the stator core 10 when the tip end portion 32Aa of each of the plurality of coil end parts 32A is detached from the recess 201 of the bending jig 200. Accordingly, as described above, the radius of curvature of the curved portion of each of the plurality of coil end parts 32A on the stator core 10 side after being bent in the C direction can be reliably reduced by moving the bending jig 200 with respect to the stator core 10 in the direction along the C direction before the tip end portion 32Aa of each of the plurality of coil end parts 32A is detached from the recess 201 of the bending jig 200. The bending angle θ2 of the tip end portion 32Aa of each of the plurality of coil end parts 32A can be appropriately adjusted by adjusting the direction D of the movement of the bending jig 200 with respect to the stator core 10 when the tip end portion 32Aa of each of the plurality of coil end parts 32A is detached from the recess 201 of the bending jig 200. As a result, for example, a necessary insulation distance of the tip end portion 32Aa of the one-side coil end portion 32 can be easily secured, and a necessary joining area of the tip end portion 32Aa of the one-side coil end portion 32 can be easily secured.

In the present embodiment, as described above, the bending step (40) is a step of bending each of the plurality of coil end parts 32A in the C direction (circumferential direction) up to the tip end portion 32Aa of each of the plurality of coil end parts 32A such that the tip end portion 32Aa of each of the plurality of coil end parts 32A is inclined to a side close to being parallel to the Z direction (axial direction) with respect to the intermediate portion 32Ab connected to the root portion 32Ac. Accordingly, since the tip end portion 32Aa of each of the plurality of coil end parts 32A is inclined to the side close to being parallel to the Z direction with respect to the intermediate portion 32Ab connected to the root portion 32Ac, the tip end portion 32Aa of the coil end part 32A can be located relatively far from the adjacent coil end part 32A. As a result, the tip end portion 32Aa of the one-side coil end portion 32 can be located relatively far from the adjacent one-side coil end portion 32, and thus the necessary insulation distance of the tip end portion 32Aa of the one-side coil end portion 32 can be easily secured.

In the present embodiment, as described above, the bending step (40) is a step of bending each of the plurality of coil end parts 32A in the C direction (circumferential direction) up to the tip end portion 32Aa of each of the plurality of coil end parts 32A such that the gap CAa between the coil end part 32A and another coil end part 32A adjacent thereto in the C direction gradually widens from the intermediate portion 32Ab toward the tip end portion 32Aa. Accordingly, in the intermediate portion 32Ab of the coil end part 32A, the gap CAa between the coil end part 32A and another coil end part 32A adjacent thereto in the C direction can be made relatively small, and thus the intermediate portion 32Ab of the coil end part 32A can be located relatively close to the adjacent coil end part 32A. As a result, the length (height) of the one-side coil end portion 32 in the Z direction (axial direction) can be made relatively small. In the tip end portion 32Aa of the coil end part 32A, the gap CAa between the coil end part 32A and another coil end part 32A adjacent thereto in the C direction can be made relatively large, and thus the tip end portion 32Aa of the coil end part 32A can be located relatively far from the adjacent coil end part 32A. As a result, the necessary insulation distance of the tip end portion 32a of the one-side coil end portion 32 can be easily secured. As a result, the necessary insulation distance of the tip end portion 32a of the one-side coil end portion 32 can be easily secured while relatively reducing the length (height) of the one-side coil end portion 32 in the Z direction.

In the present embodiment, as described above, the bending step (40) is a step of bending each of the plurality of coil end parts 32A in the C direction up to the tip end portion 32Aa of each of the plurality of coil end parts 32A such that the root portion 32Ac is curved to be gradually inclined to the side away from being parallel to the Z direction as approaching the intermediate portion 32Ab, the intermediate portion 32Ab extends linearly, or is curved to be gradually inclined to the side close to being parallel to the Z direction as approaching the tip end portion 32Aa, and the tip end portion 32Aa is curved to be gradually inclined to the side close to being parallel to the Z direction as approaching the tip end. Accordingly, the one-side coil end portion 32 (coil end portion) capable of smoothly connecting the root portion 32c and the intermediate portion 32b and smoothly connecting the intermediate portion 32b and the tip end portion 32a can be implemented. As a result, the necessary insulation distance of the tip end portion 32a of the one-side coil end portion 32 can be easily secured while smoothly connecting the root portion 32c and the intermediate portion 32b and the intermediate portion 32b and the tip end portion 32a.

In the present embodiment, as described above, the one-side coil end portion 32 (coil end portion) is bent in the C direction (circumferential direction) of the stator core 10 up to the tip end portion 32a. Accordingly, the one-side coil end portion 32 is bent in the C direction of the stator core 10 up to the tip end portion 32a, and thus the length (height) of the one-side coil end portion 32 in the Z direction (axial direction) can be reduced as compared with the case where the tip end portion 32a of the one-side coil end portion 32 is not bent. Since the one-side coil end portion 32 includes the tip end portion 32a inclined to the side close to being parallel to the Z direction with respect to the intermediate portion 32b, the tip end portion 32a of the one-side coil end portion 32 can be located relatively far from the adjacent one-side coil end portion 32. As a result, the necessary insulation distance of the tip end portion 32a of the one-side coil end portion 32 can be easily secured.

In the present embodiment, as described above, the one-side coil end portion 32 (coil end portion) is configured such that the gap Ca between the one-side coil end portion 32 and another one-side coil end portion 32 adjacent thereto in the C direction gradually widens from the intermediate portion 32b toward the tip end portion 32a. Accordingly, in the intermediate portion 32b of the one-side coil end portion 32, the gap Ca between the one-side coil end portion 32 and another one-side coil end portion 32 adjacent thereto in the C direction can be made relatively small, and thus the intermediate portion 32b of the one-side coil end portion 32 can be located relatively close to the adjacent one-side coil end portion 32. As a result, the length (height) of the one-side coil end portion 32 in the axial direction can be made relatively small. In the tip end portion 32a of the one-side coil end portion 32, the gap Ca between the one-side coil end portion 32 and another one-side coil end portion 32 adjacent thereto in the C direction can be made relatively large, and thus the tip end portion 32a of the one-side coil end portion 32 can be located relatively far from the adjacent one-side coil end portion 32. As a result, the necessary insulation distance of the tip end portion 32a of the one-side coil end portion 32 can be easily secured. As a result, the necessary insulation distance of the tip end portion 32a of the one-side coil end portion 32 can be easily secured while relatively reducing the length (height) of the one-side coil end portion 32 in the axial direction.

In the present embodiment, as described above, the root portion 32c is curved to be gradually inclined to the side away from being parallel to the Z direction (axial direction) as approaching the intermediate portion 32b, the intermediate portion 32b extends linearly or is curved to be gradually inclined to the side close to being parallel to the Z direction as approaching the tip end portion, and the tip end portion 32a is curved to be gradually inclined to the side close to being parallel to the Z direction as approaching the tip end. Accordingly, the root portion 32c and the intermediate portion 32b can be smoothly connected, and the intermediate portion 32b and the tip end portion 32a can be smoothly connected. As a result, the necessary insulation distance of the tip end portion 32a of the one-side coil end portion 32 can be easily secured while smoothly connecting the root portion 32c and the intermediate portion 32b and the intermediate portion 32b and the tip end portion 32a.

### Modification

The embodiment disclosed herein should be considered to be illustrative and not restrictive in all respects. The scope disclosed here is indicated not by the description of the above embodiment but by the claims, and all changes (modifications) within the meaning and scope equivalent to the claims are included.

For example, in the above-described embodiment, an example has been shown in which the bending step (S40) is a step of bending each of the plurality of coil end parts 32A in the C direction (circumferential direction) up to the tip end portion 32Aa of each of the plurality of coil end parts 32A while moving the bending jig 200 with respect to the stator core 10 in the direction parallel to the end surface 10a of the stator core 10 and in the direction along the C direction, but this disclosure is not limited thereto. In this disclosure, the bending step may be a step of bending each of a plurality of coil end parts in a circumferential direction up to a tip end portion of each of the plurality of coil end parts while moving a bending jig with respect to a stator core in a direction not parallel to an end surface of the stator core and in a direction along the circumferential direction. For example, the bending step may be a step of bending each of a plurality of coil end parts in a circumferential direction up to a tip end portion of each of the plurality of coil end parts while moving a bending jig with respect to a stator core in a direction inclined to a side away from an end surface of the stator core with respect to a direction parallel to the end surface of the stator core and in a direction along the circumferential direction.

In the above-described embodiment, an example is shown in which the bending step (S40) is a step of bending each of the plurality of coil end parts 32A in the C direction (circumferential direction) up to the tip end portion 32Aa of each of the plurality of coil end parts 32A by moving the bending jig 200 with respect to the stator core 10 in the direction along the C direction with each of the plurality of coil end parts 32A inserted into the recess 201 of the bending jig 200, the recess 201 extending along the coil end part 32A, but this disclosure is not limited thereto. In this disclosure, the bending step is a step of bending each of a plurality of coil end parts in a circumferential direction up to a tip end portion of each of the plurality of coil end parts by moving a stator core with respect to a bending jig in a direction along the circumferential direction with each of the plurality of coil end parts inserted into a recess of the bending jig, the recess extending along the coil end part.

In the above-described embodiment, an example has been shown in which the bending step (S40) is a step of bending each of the plurality of coil end parts 32A in the C direction up to the tip end portion 32Aa of each of the plurality of coil end parts 32A by moving the bending jig 200 with respect to the stator core 10 in the direction along the C direction before the tip end portion 32Aa of each of the plurality of coil end parts 32A is detached from the recess 201 of the bending jig 200, and moving the bending jig 200 with respect to the stator core 10 while bringing the tip end portion 32Aa of each of the plurality of coil end parts 32A into contact with the protrusion 202 located at the end portion of the bending jig 200 on the stator core 10 side after the tip end portion 32Aa of each of the plurality of coil end parts 32A is detached from the recess 201 of the bending jig 200, but this disclosure is not limited thereto. In this disclosure, the bending step may be a step of bending each of a plurality of coil end parts in a circumferential direction up to a tip end portion of each of the plurality of coil end parts by relatively moving a bending jig with respect to a stator core in a direction along the circumferential direction before the tip end portion of each of the plurality of coil end parts is detached from a recess of the bending jig, and moving the bending jig with respect to the stator core without bringing the tip end portion of each of the plurality of coil end parts into contact with a protrusion located at an end portion of the bending jig on a stator core side after the tip end portion of each of the plurality of coil end parts is detached from the recess of the bending jig.

In the above-described embodiment, an example has been shown in which each of the plurality of recesses 201 of the bending jig 200 is formed in a slit shape, but this disclosure is not limited thereto. In this disclosure, each of a plurality of recesses of a bending jig may be formed in a groove shape or a hole shape.

A method for producing a stator according to a first aspect of this disclosure includes: a segment coil insertion step of inserting a segment coil including a coil end part serving as a coil end portion into each of a plurality of slots of a stator core such that the coil end part protrudes from an end surface of the stator core in an axial direction along the axial direction to an outer side in the axial direction; and a bending step of, after the segment coil insertion step, bending each of a plurality of the coil end parts in a circumferential direction of the stator core up to a tip end portion of each of the plurality of coil end parts by relatively moving a bending jig with respect to the stator core in a direction along the circumferential direction with each of the plurality of coil end parts inserted into a recess of the bending jig, the recess extending along the coil end part.

In the method for producing a stator according to the first aspect of this disclosure, as described above, the bending step is a step of bending each of the plurality of coil end parts in the circumferential direction of the stator core up to the tip end portion of each of the plurality of coil end parts by relatively moving the bending jig with respect to the stator core in the direction along the circumferential direction with each of the plurality of coil end parts inserted into the recess of the bending jig, the recess extending along the coil end part. Accordingly, when each of the plurality of coil end parts is bent in the circumferential direction, a length of a portion of each of the plurality of coil end parts that is inserted into the recess of the bending jig gradually decreases, and thus a load application point of the bending jig on the coil end part can be moved from a stator core side to a bending jig side in the coil end part. That is, when each of the plurality of coil end parts is bent in the circumferential direction, the load application point of the bending jig on the coil end part changes from a position relatively close to an end portion of the coil end part on the stator core side to a position relatively far from the end portion. Accordingly, when each of the plurality of coil end parts is bent in the circumferential direction, a radius of curvature of a curved portion of each of the plurality of coil end parts on the stator core side after being bent in the circumferential direction can be reduced as compared with a case where the load application point of the bending jig on the coil end part is normally located at a position relatively far from the end portion of the coil end part on the stator core side, and thus a degree of bending of the curved portion can be increased. As a result, a length (height) of the coil end portion in an axial direction can be made relatively small. Since each of the plurality of coil end parts is bent in the circumferential direction up to the tip end portion of each of the plurality of coil end parts, the length (height) of the coil end part in the axial direction can be reduced as compared with a case where the tip end portion of each of the plurality of coil end parts is not bent. Accordingly, the length (height) of the coil end portion in the axial direction can be made relatively small.

In the method for producing a stator according to the first aspect, preferably, the bending step is a step of bending each of the plurality of coil end parts in the circumferential direction up to the tip end portion of each of the plurality of coil end parts by relatively moving the bending jig with respect to the stator core in the direction along the circumferential direction before the tip end portion of each of the plurality of coil end parts is detached from the recess of the bending jig, and relatively moving the bending jig with respect to the stator core while bringing the tip end portion of each of the plurality of coil end parts into contact with a protrusion located at an end portion of the bending jig on a stator core side after the tip end portion of each of the plurality of coil end parts is detached from the recess of the bending jig.

With such a structure, the length of the portion of each of the plurality of coil end parts that is inserted into the recess of the bending jig is gradually reduced by relatively moving the bending jig with respect to the stator core in the direction along the circumferential direction before the tip end portion of each of the plurality of coil end parts is detached from the recess of the bending jig, and thus the load application point of the bending jig on the coil end part can be reliably moved from the stator core side to the bending jig side in the coil end part. Accordingly, when each of the plurality of coil end parts is bent in the circumferential direction, the radius of curvature of the curved portion of each of the plurality of coil end parts on the stator core side after being bent in the circumferential direction can be reliably reduced as compared with a case where the load application point of the bending jig on the coil end part is normally located at a position relatively far from the end portion of the coil end part on the stator core side. The tip end portion of each of the plurality of coil end parts can be pressed by the protrusion of the bending jig by relatively moving the bending jig with respect to the stator core while bringing the tip end portion of each of the plurality of coil end parts into contact with the protrusion located at the end portion of the bending jig on the stator core side after the tip end portion of each of the plurality of coil end parts is detached from the recess of the bending jig, and thus the length (height) of the coil end part in the axial direction can be reliably reduced.

In the method for producing a stator according to the first aspect, preferably, the bending step is a step of bending each of the plurality of coil end parts in the circumferential direction up to the tip end portion of each of the plurality of coil end parts while adjusting a bending angle of the tip end portion of each of the plurality of coil end parts by relatively moving the bending jig with respect to the stator core in the direction along the circumferential direction before the tip end portion of each of the plurality of coil end parts is detached from the recess of the bending jig and adjusting a direction of relative movement of the bending jig with respect to the stator core when the tip end portion of each of the plurality of coil end parts is detached from the recess of the bending jig.

With such a structure, as described above, the radius of curvature of the curved portion of each of the plurality of coil end parts on the stator core side after being bent in the circumferential direction can be reliably reduced by relatively moving the bending jig with respect to the stator core in the direction along the circumferential direction before the tip end portion of each of the plurality of coil end parts is detached from the recess of the bending jig. The bending angle of the tip end portion of each of the plurality of coil end parts can be appropriately adjusted by adjusting the direction of the relative movement of the bending jig with respect to the stator core when the tip end portion of each of the plurality of coil end parts is detached from the recess of the bending jig. As a result, for example, a necessary insulation distance of the tip end portion of the coil end portion can be easily secured, and a necessary joining area of the tip end portion of the coil end portion can be easily secured.

In the method for producing a stator according to the first aspect, preferably, the bending step is a step of bending each of the plurality of coil end parts in the circumferential direction up to the tip end portion of each of the plurality of coil end parts such that the tip end portion of each of the plurality of coil end parts is inclined to a side close to being parallel to the axial direction with respect to an intermediate portion connected to a root portion.

With such a structure, since the tip end portion of each of the plurality of coil end parts is inclined to the side close to being parallel to the axial direction with respect to the intermediate portion connected to the root portion, the tip end portion of the coil end part can be located relatively far from the adjacent coil end part. As a result, the tip end portion of the coil end portion can be located relatively far from the adjacent coil end portion, and thus the necessary insulation distance of the tip end portion of the coil end portion can be easily secured.

A stator according to a second aspect of this disclosure includes: a stator core including a slot; and a coil formed by joining a plurality of segment coils, each of which includes a slot housing portion housed in the slot and a coil end portion protruding from an end surface of the stator core in an axial direction along the axial direction to an outer side in the axial direction, wherein the coil end portion is bent in a circumferential direction of the stator core up to a tip end portion, and includes a root portion connected to the slot housing portion, an intermediate portion connected to the root portion, and the tip end portion connected to the intermediate portion and inclined to a side close to being parallel to the axial direction with respect to the intermediate portion.

In the stator according to the second aspect of the disclosure, as described above, the coil end portion is bent in the circumferential direction of the stator core up to the tip end portion. Accordingly, the coil end portion is bent in the circumferential direction of the stator core up to the tip end portion, and thus a length (height) of the coil end portion in the axial direction can be reduced as compared with a case where the tip end portion of the coil end portion is not bent. Since the coil end portion includes the tip end portion inclined to an outer side in the axial direction with respect to the intermediate portion, the tip end portion of the coil end portion can be located relatively far from the adjacent coil end portion. As a result, a necessary insulation distance of the tip end portion of the coil end portion can be easily secured.

In the stator according to the second aspect, preferably, the coil end portion is configured such that a gap between the coil end portion and another coil end portion adjacent thereto in the circumferential direction gradually widens from the intermediate portion toward the tip end portion.

With such a structure, in the intermediate portion of the coil end portion, the gap between the coil end portion and another coil end portion adjacent thereto in the circumferential direction can be made relatively small, and thus the intermediate portion of the coil end portion can be located relatively close to the adjacent coil end portion. As a result, a length (height) of the coil end portion in the axial direction can be made relatively small. In the tip end portion of the coil end portion, the gap between the coil end portion and another coil end portion adjacent thereto in the circumferential direction can be made relatively large, and thus the tip end portion of the coil end portion can be located relatively far from the adjacent coil end portion. As a result, a necessary insulation distance of the tip end portion of the coil end portion can be easily secured. As a result, a necessary insulation distance of the tip end portion of the coil end portion can be easily secured while relatively reducing the length (height) of the coil end portion in the axial direction.

In the stator according to the second aspect, preferably, the root portion is curved to be gradually inclined to a side away from being parallel to the axial direction as approaching the intermediate portion, the intermediate portion extends linearly or is curved to be gradually inclined to a side close to being parallel to the axial direction as approaching the tip end portion, and the tip end portion is curved to be gradually inclined to a side close to being parallel to the axial direction as approaching a tip end.

With such a structure, the root portion and the intermediate portion can be smoothly connected, and the intermediate portion and the tip end portion can be smoothly connected. As a result, a necessary insulation distance of the tip end portion of the coil end portion can be easily secured while smoothly connecting the root portion and the intermediate portion and the intermediate portion and the tip end portion.

In the present application, in the method for producing a stator according to the first aspect, the Following configuration is also considered.

### Appendix 1

In the above-described configuration in which the tip end portion of each of the plurality of coil end parts is inclined to the side close to being parallel to the axial direction with respect to the intermediate portion connected to the root portion, preferably, the bending step is a step of bending each of the plurality of coil end parts in the circumferential direction up to the tip end portion of each of the plurality of coil end parts such that the gap between the coil end part and another coil end part adjacent thereto in the circumferential direction gradually widens from the intermediate portion toward the tip end portion.

With such a structure, in the intermediate portion of the coil end part, the gap between the coil end part and another coil end part adjacent thereto in the circumferential direction can be made relatively small, and thus the intermediate portion of the coil end part can be located relatively close to the adjacent coil end part. As a result, the length (height) of the coil end portion in the axial direction can be made relatively small. In the tip end portion of the coil end part, the gap between the coil end part and another coil end part adjacent thereto in the circumferential direction can be made relatively large, and thus the tip end portion of the coil end part can be located relatively far from the adjacent coil end part. As a result, a necessary insulation distance of the tip end portion of the coil end portion can be easily secured. As a result, a necessary insulation distance of the tip end portion of the coil end portion can be easily secured while relatively reducing the length (height) of the coil end portion in the axial direction.

### Appendix 2

In the above-described configuration in which the tip end portion of each of the plurality of coil end parts is inclined to the side close to being parallel to the axial direction with respect to the intermediate portion connected to the root portion, preferably, the bending step is a step of bending each of the plurality of coil end parts in the circumferential direction up to the tip end portion of each of the plurality of coil end parts such that the root portion is curved to be gradually inclined to a side away from being parallel to the axial direction as approaching the intermediate portion, the intermediate portion extends linearly or is curved to be gradually inclined to a side close to being parallel to the axial direction as approaching the tip end portion, and the tip end portion is curved to be gradually inclined to a side close to being parallel to the axial direction as approaching a tip end.

With such a structure, the coil end portion capable of smoothly connecting the root portion and the intermediate portion and smoothly connecting the intermediate portion and the tip end portion can be implemented. As a result, a necessary insulation distance of the tip end portion of the coil end portion can be easily secured while smoothly connecting the root portion and the intermediate portion and the intermediate portion and the tip end portion.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method for producing a stator, the method comprising:
a segment coil insertion step of inserting a segment coil including a coil end part serving as a coil end portion into each of a plurality of slots of a stator core such that the coil end part protrudes from an end surface of the stator core in an axial direction along the axial direction to an outer side in the axial direction; and
a bending step of, after the segment coil insertion step, bending each of a plurality of the coil end parts in a circumferential direction of the stator core up to a tip end portion of each of the plurality of coil end parts by relatively moving a bending jig with respect to the stator core in a direction along the circumferential direction with each of the plurality of coil end parts inserted into a recess of the bending jig, the recess extending along the coil end part.

2. The method for producing a stator according to claim 1, wherein the bending step is a step of bending each of the plurality of coil end parts in the circumferential direction up to the tip end portion of each of the plurality of coil end parts by relatively moving the bending jig with respect to the stator core in the direction along the circumferential direction before the tip end portion of each of the plurality of coil end parts is detached from the recess of the bending jig and relatively moving the bending jig with respect to the stator core while bringing the tip end portion of each of the plurality of coil end parts into contact with a protrusion located at an end portion of the bending jig on a stator core side after the tip end portion of each of the plurality of coil end parts is detached from the recess of the bending jig.

3. The method for producing a stator according to claim 1, wherein the bending step is a step of bending each of the plurality of coil end parts in the circumferential direction up to the tip end portion of each of the plurality of coil end parts while adjusting a bending angle of the tip end portion of each of the plurality of coil end parts by relatively moving the bending jig with respect to the stator core in the direction along the circumferential direction before the tip end portion of each of the plurality of coil end parts is detached from the recess of the bending jig and adjusting a direction of relative movement of the bending jig with respect to the stator core when the tip end portion of each of the plurality of coil end parts is detached from the recess of the bending jig.

4. The method for producing a stator according to claim 1, wherein the bending step is a step of bending each of the plurality of coil end parts in the circumferential direction up to the tip end portion of each of the plurality of coil end parts such that the tip end portion of each of the plurality of coil end parts is inclined to a side close to being parallel to the axial direction with respect to an intermediate portion connected to a root portion.

5. A stator comprising:
a stator core including a slot; and
a coil formed by joining a plurality of segment coils, each of which includes a slot housing portion housed in the slot and a coil end portion protruding from an end surface of the stator core in an axial direction along the axial direction to an outer side in the axial direction, wherein
the coil end portion is bent in a circumferential direction of the stator core up to a tip end portion, and includes a root portion connected to the slot housing portion, an intermediate portion connected to the root portion, and the tip end portion connected to the intermediate portion and inclined to a side close to being parallel to the axial direction with respect to the intermediate portion.

6. The stator according to claim 5, wherein the coil end portion is configured such that a gap between the coil end portion and another coil end portion adjacent thereto in the circumferential direction gradually widens from the intermediate portion toward the tip end portion.

7. The stator according to claim 5, wherein
the root portion is curved to be gradually inclined to a side away from being parallel to the axial direction as approaching the intermediate portion,
the intermediate portion extends linearly or is curved to be gradually inclined to a side close to being parallel to the axial direction as approaching the tip end portion, and
the tip end portion is curved to be gradually inclined to a side close to being parallel to the axial direction as approaching a tip end.
